(19) United States
(12) Patent Application Publication
(10) Pub. No.: US 2011/0284117 A1
(43) Pub. Date: Nov. 24, 2011

(54) FUEL COMPOSITIONS

(76) Inventors: Claire Ansell, Cheshire (GB); Richard Hugh Clark, Cheshire (GB); Christopher William Clayton, Cheshire (GB); Paul Anthony Stevenson, Cheshire (GB); Robert Wilfred Matthews Wardle, Cheshire (GB)

(21) Appl. No.: 12/679,983

(22) PCT Filed: Sep. 26, 2008
(86) PCT No.: PCT/US08/77770

§ 371 Date: Aug. 1, 2011

Related U.S. Application Data
(60) Provisional application No. 60/975,837, filed on Sep. 28, 2007.

(51) Int. Cl. F16L 9/14; B23P 19/04

(52) U.S. Cl. 138/140; 29/428

(57) ABSTRACT

A system comprising a liner at an interior of the pipe; at least one dry fiber tri-axial braid layer exterior to the liner, the tri-axial braid layer comprising a plurality of axial fibers, a plurality of clockwise fibers, and a plurality of counterclockwise fibers.

### FIELD OF THE INVENTION

The present invention relates to pipe systems and methods.

### DESCRIPTION OF THE RELATED ART

Drilling for and/or producing hydrocarbons or the like from subterranean deposits which exist under a body of water usually requires the use of multiple pipes and other conduits to transport fluids and/or gases. Such pipes could be used to transport fluids and/or gases from a wellhead to a manifold; from a manifold to a production facility such as a platform, TLP, or spar; and/or from a production facility to the shore.

The cost and difficulty of installing such pipes generally increases with the length of the pipe and the depth at which the pipe will be installed. Pipes are often installed from floating vessels, for example joints of a pipe may be assembled on a vessel and installed using a S-lay or J-lay configuration. Some pipes are also installed using a S-lay or J-lay configuration from a spool on the vessel.

It is known to have composite pipes made with fibers embedded in a thermoset matrix. One problem with fiber reinforced thermoset pipes is their relative low flexibilities. Such pipes can be may made by processes such as filament winding, pultrusion, and/or extrusion.

U.S. Pat. No. 6,857,452 discloses a spoolable composite tube capable of being spooled onto a reel for storage and for use in oil field applications. The spoolable tube exhibits unique anistropic characteristics that provide improved burst and collapse pressures, increased tensile strength, compression strength, and load carrying capacity, while still remaining sufficiently bendable to be spooled onto a reel in an open bore configuration. The spoolable composite tube can include an inner liner, an interface layer, fiber composite layers, a pressure barrier layer, and an outer protective layer. The fiber composite layers can have a unique triaxial braid structure. These layers are bonded together to form an integral pipe-wall construction. U.S. Pat. No. 6,857,452 is herein incorporated by reference in its entirety.

U.S. Pat. No. 6,666,778 discloses a golf club shaft having a braid layer including first and second diagonal yarns. The diagonal yarns are positioned at the degrees of orientation (+.theta., −.theta.) of +30 to +60 degrees and −30 to −60 degrees against the longitudinal axis of the shaft, respectively. The braid layer minimizes spaces S between the diagonal yarns. With the shaft, the ratio of the longitudinal modulus of the shaft during a swing to the longitudinal modulus of the shaft when the head speed is zero gradually increases along with the increase in the head speed, thus suppressing the shaft's deformation caused by centrifugal force during a swing and facilitating swings of the club. U.S. Pat. No. 6,666,778 is herein incorporated by reference in its entirety.

U.S. Pat. No. 6,510,961 discloses a method of producing a generally tubular, reinforced, structure including an inner layer of braided material having a predefined indentation configuration, the method including the steps of providing a mandrel having a shape and configuration of indentations corresponding to the shape and indentation configuration of the inner layer, providing a plurality of support members in the vicinity of at least some of the indentations on the mandrel, the support members protruding a predetermined distance radially outwardly from the mandrel, depositing the inner layer over the mandrel and the support members, and removing the support members to a position in which the support members do not protrude the surface of the mandrel. U.S. Pat. No. 6,510,961 is herein incorporated by reference in its entirety.

U.S. Pat. No. 6,148,865 discloses a sleeve, a method of manufacturing a rigid, tubular article manufactured from the sleeve and an article made according to the method. The sleeve has elastic crisscrossing first and second filaments which enable the sleeve to be expandable in a radial direction and longitudinally extending filaments of a reinforcing non-elastic material such as carbon, kevlar or fiberglass to reinforce the sleeve. The sleeve is placed over a mandrel having alternating larger and small cross-sections. The sleeve is subjected to heat and pressure causing the individual filaments to fuse together forming a solid tubular part. Upon having cooled, the article is removed and a rigid tubular article, for example, a rifle scope tube is thereby formed. Also, a sleeve is provided which in its relaxed state is contracted longitudinally and expanded radially. The sleeve is slipped into a pipe joint, for example, when in its stretched state and is then released. The sleeve is heated to fuse the sleeve into a solid part and thereby reinforce the joint. U.S. Pat. No. 6,148,865 is herein incorporated by reference in its entirety.

There are needs in the art for one or more of the following: apparatus and methods for providing alternative spoolable tubulars to be used in an offshore environment, which do not suffer from certain disadvantages of the prior art apparatus and methods; collapsible tubular members; light weight tubular members; high strength tubular members; flexible tubular members; and/or tubulars suitable for multiple deployments.

These and other needs in the art will become apparent to those of skill in the art upon review of this specification, including its drawings and claims.

### SUMMARY OF THE INVENTION

One aspect of invention provides a system comprising a liner at an interior of the pipe; at least one dry fiber tri-axial braid layer exterior to the liner, the tri-axial braid layer comprising a plurality of axial fibers, a plurality of clockwise fibers, and a plurality of counterclockwise fibers.

Another aspect of invention provides a method of manufacturing a pipe, comprising providing a liner; and triaxially braiding a plurality of fibers about the liner to form at least one dry fiber layer.

Advantages of the invention may include one or more of the following: improved apparatus and methods for providing alternative spoolable tubulars to be used in an offshore environment; collapsible tubular members; light weight tubular members; high strength tubular members; flexible tubular members; and/or tubulars suitable for multiple deployments.

These and other aspects of the invention will become apparent to those of skill in the art upon review of this specification, including its drawings and claims.

### BRIEF DESCRIPTION OF THE DRAWINGS

FIGS. 1a and 1b show a tubular liner.

FIGS. 1c and 1d show a fiber reinforced tubular liner.

FIG. 2a shows a fiber reinforced tubular liner.

FIGS. 3a and 3b show a collapsible fiber reinforced tubular liner system.

### DETAILED DESCRIPTION OF THE INVENTION

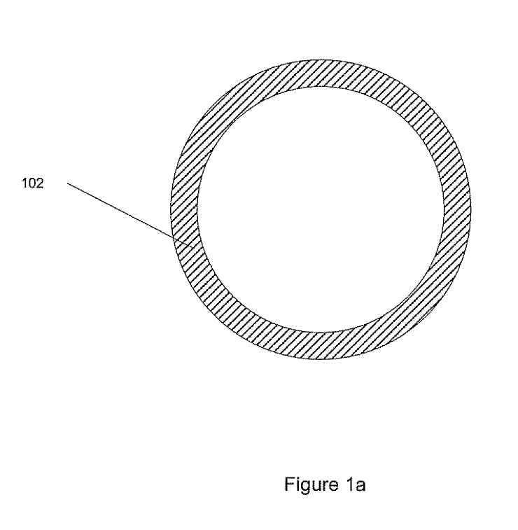

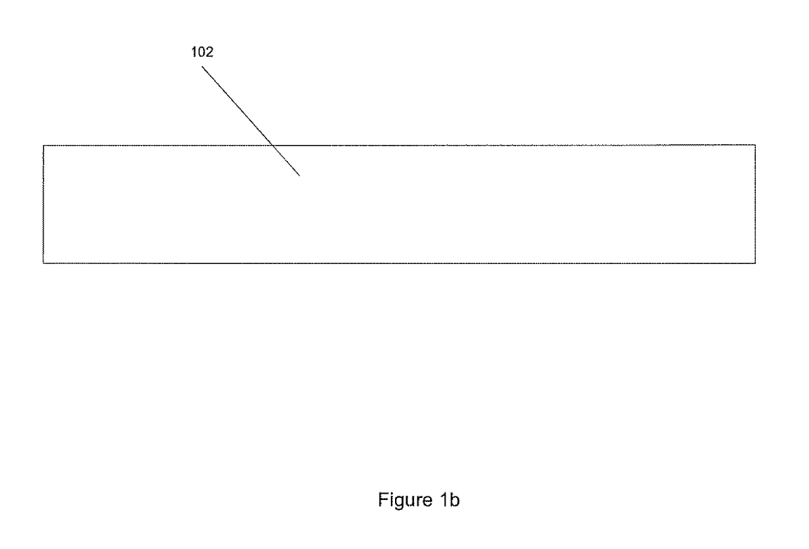

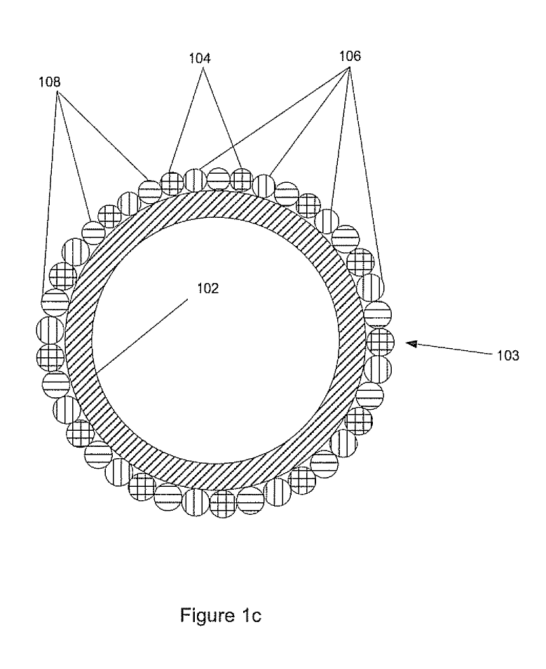

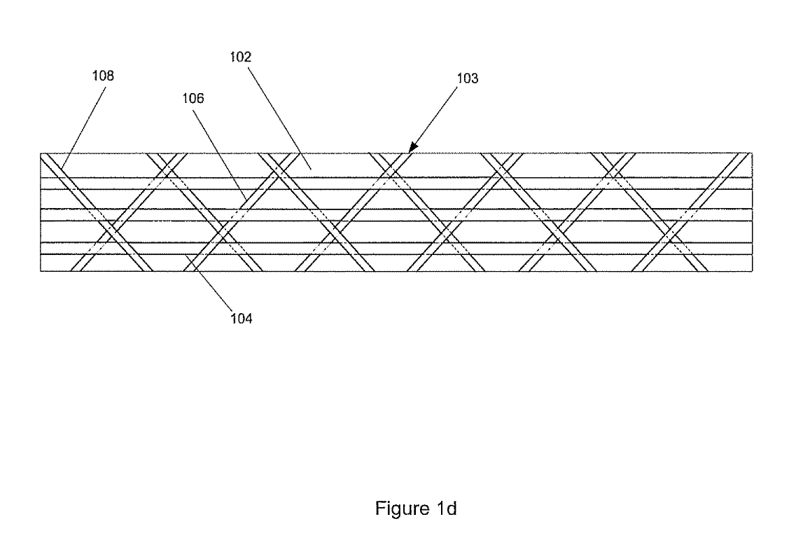

FIGS. 1a and 1b:

Referring now to FIG. 1a, an end view of liner 102 is shown, and referring to FIG. 1b, a side view of liner 102 is shown. Liner 102 serves as a pressure containment member to resist leakage of internal fluids from within a pipe.

In one embodiment, liner 102 is metallic, or liner 102 may be formed of polymeric materials. In the case of a metal liner, the metals forming the liner can include, individually or in combination, steel, copper, stainless steel, or corrosion resistant alloys. In the case of a polymeric liner, the polymeric materials making up the liner 102 can be thermoplastic or thermoset materials. For instance, the liner can be formed of homo-polymers, co-polymers, composite polymers, or co-extruded composite polymers. Homo-polymers refer to materials formed from a single polymer, co-polymers refers to materials formed by blending two or more polymers, and composite polymers refer to materials formed of two or more discrete polymer layers that have been permanently bonded or fused. The polymeric materials forming the inner liner are preferably selected from a group of various polymers, including but not limited to: polyvinylidene fluoride, etylene tetrafluoroethylene, cross-linked polyethylene (“PEX”), polyethylene, and polyester. Further exemplary thermoplastic polymers include materials such as polyphenylene sulfide, polyethersulfone, polyethylene terephthalate, polyamide, polypropylene, and acetyl. In another embodiment, liner 102 is formed of elastomeric materials. Exemplary elastomeric materials, include NBR and HNBR.

Liner 102 can also include fibers to increase the load carrying strength of the liner and the overall load carrying strength of the spoolable composite tube. Exemplary fibers include graphite, kevlar, fiberglass, boron, polyester fibers, liquid crystal fibers, HMPE fibers, and aramid.

The liner 102 can be formed to be resistive to corrosive chemicals such as heterocyclic amines, inorganic sulfur compound, and nitrogenous and acetylenic organic compounds.

In other embodiments, liner 102 comprises co-polymers formed to achieve enhanced liner characteristics, such as corrosion resistance, wear resistance and/or electrical resistance. For instance, liner 102 can be formed of a polymer and an additive such that the liner has a high electrical resistance or such that the liner dissipates static charge buildup within a pipe. In particular, carbon black can be added to a polymeric material to form a liner 102. Accordingly, the carbon black additive forms a liner 102 having an increased electrical conductivity that provides a static discharge capability. The static discharge capability advantageously prevents the ignition of flammable fluids being circulated within a pipe.

Liner 102 may have a radial thickness from about 0.02 to about 2.0 inches, for example from about 0.05 to about 0.25 inches.

FIGS. 1c and 1d:

Referring now to FIG. 1c, an end view of liner 102 is shown, with tri-axial braid system 103 exterior to liner 102. Referring now to FIG. 1d, a side view of liner 102 is shown, with tri-axial braid system 103 exterior to liner 102. Tri-axial braid system 103 includes axial fibers 104, clockwise fibers 106, and counter-clockwise fibers 108. Liner 102 serves as a pressure containment member to resist leakage of internal fluids from within a pipe.

The tri-axial braid system 103 can be formed of a number of plies, each ply having dry fibers, such that the fibers are not disposed within a matrix, such as a polymer, resin, or thermoplastic matrix. The dry fibers may include structural fibers and flexible yarn components. The structural fibers may be formed of carbon, nylon, polyester, HMPE, liguid crystal, aramid, thermoplastic, glass or materials with reasonable strength and elongation capabilities. The flexible yarn components may be formed of nylon, polyester, aramid, thermoplastic, or glass. The fibers included in tri-axial braid system 103 can be fiber tows, strands, woven, braided, knitted, or stitched. The tri-axial braid system 103 can be formed through braiding processes as are known in the art. Liner 102 and the tri-axial braid system 103 form a composite tube.

The fiber components can be formed of carbon, glass, aramid (such as kevlar or twaron), thermoplastic, nylon, HMPE, liguid crystal, or polyester. Within each layer of the tri-axial braid system 103, fiber components 104, 106 and 108 can be formed of either the same material or a combination of different materials. Further, fiber components in different layers of the tri-axial system 103 can be formed of the same materials for a combination different materials.

In the pipe body, liner 102 may not be bonded to the tri-axial braid system 103.

Helically oriented fibers are fibers that follow a spiral path. Typically, helical fibers spiral around the liner of the composite tube or they spiral around underlying layers of the composite tube. For example, a helically oriented fiber follows a path comparable to the grooves around the shaft of a common screw. A helical fiber can be described as having an axial vector, an angle of orientation, and a wrapping direction. The axial vector indicates that the helical fiber can follow a path along the length of a tube as it spirals around the tube, as opposed to a fiber that continually wraps around a particular section of the tube without extending along the length of the tube. The angle of orientation of the helical fiber indicates the helical fiber's angle relative to a defined axis, such as the longitudinal axis of the tube. For example, a helical fiber having an angle of 0 degrees is a fiber that extends parallel to the longitudinal axis and that does not wrap around the tube, while a fiber having an angle of 90 degrees circumferentially wraps around the tube without extending along the length of the tube. The wrapping direction of the helical fiber is described as either clockwise or counter-clockwise wrapping around the tube.

Fiber 104 extends helically or substantially axially relative to the longitudinal axis of the tube. The helically oriented fiber component 106 and 108 tend to tightly bind the longitudinal fiber component 104 in addition to providing increased bending stiffness along the axis and increased torsional strength around the axis. The helically oriented fiber components 106 and 108 can be interwoven amongst themselves. To this end, successive crossings of two fiber components 106 and 108 may have successive “over” and “under” geometries.

Fiber 104 may make an angle from about +30 degrees to about −30 degrees with the longitudinal axis of liner 102, for example from about +15 degrees to about −15 degrees, or from about +5 degrees to about −5 degrees. Fiber 106 may make an angle from about +90 degrees to about −90 degrees with the longitudinal axis of liner 102, for example from about +60 degrees to about −60 degrees, or from about +45 degrees to about −45 degrees. Fiber 108 may make an angle from about +90 degrees to about −90 degrees with the longitudinal axis of liner 102, for example from about +60 degrees to about −60 degrees, or from about +45 degrees to about −45 degrees. Fiber 106 may make an angle from about +90 degrees to about −90 degrees with fiber 104, for example from about +60 degrees to about −60 degrees, or from about +45 degrees to about −45 degrees. Fiber 108 may make an angle from about +90 degrees to about −90 degrees with fiber 104, for example from about +60 degrees to about −60 degrees, or from about +45 degrees to about −45 degrees. Fiber 106 may make an angle from about +90 degrees to about −90 degrees with fiber 108, for example from about +60 degrees to about −60 degrees, or from about +45 degrees to about −45 degrees.

The dry fiber layer layer may include a triaxial braid that comprises an axially extending fiber component 104, a clockwise extending second fiber component 106 and a counter-clockwise extending third fiber component 108, wherein the fiber 104 is interwoven with either fiber 106 and/or fiber 108. Each helically oriented fiber 106, 108, can therefore be considered a braiding fiber. A single braiding fiber, such as fiber 106 may bind the fiber component of a given ply together by interweaving the braiding fiber 106 with itself and with axially extending fiber 104. A fiber is interwoven with itself, for example, by successively wrapping the fiber about the member and looping the fiber with itself at each wrap.

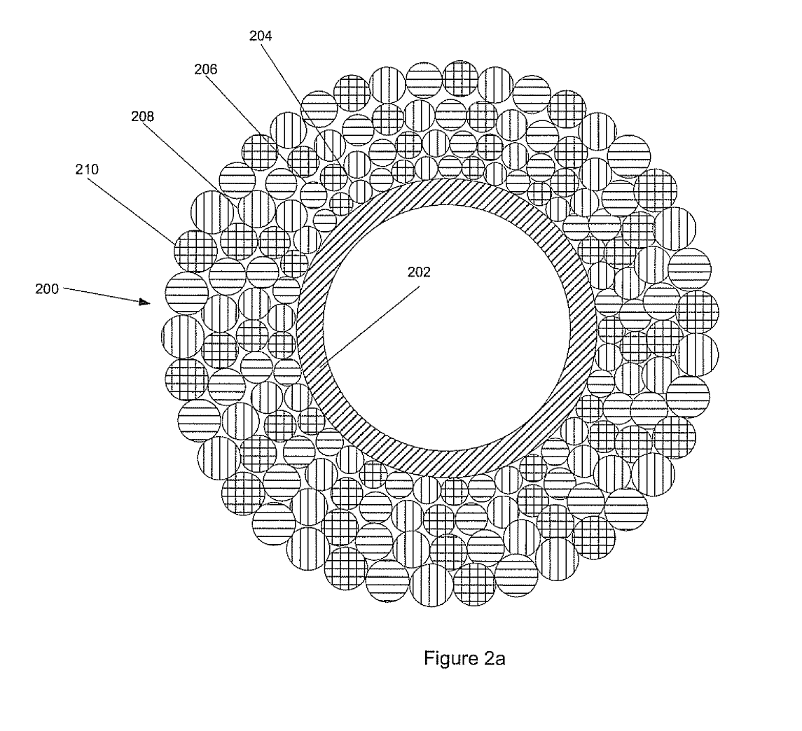

FIG. 2a:

Referring now to FIG. 2a, composite tube system 200 having inner-liner 202, first dry fiber layer layer 204, second dry fiber layer layer 206, third dry fiber layer 208, and fourth dry fiber layer 210. Each of the dry fiber layers is formed of fibers, and each of the dry fiber layers successively encompasses and surrounds the underlying dry fiber layer or liner 102. At least one of the dry fiber layers includes a helically oriented fiber. At least one of the dry fiber layers may contain a ply such as tri-axial braid system 103 as described above with reference to FIGS. 1c and 1d. In particular, one or more of the dry fiber layers may have a first helically extending fiber, a second clockwise extending fiber, and a third counterclockwise extending fiber wherein the first fiber is interwoven with at least one of the second and third fibers. The other dry fiber layers may also contain fibers, axially extending, circumferentially wrapped, or helically wrapped, biaxially braided or triaxially braided.

The fibers in each of the dry fiber layers may all be selected from the same material, or the fibers in each of the dry fiber layers layers may be selected from different materials. For example, layer 204 can comprise a triaxially braided ply having clockwise and counter-clockwise helically oriented fibers formed of polyester and having a helically extending fiber formed of glass; layer 206 can comprise a ply having a circumferentially wound kevlar fiber; and layer 208 can comprise a triaxially braided ply having a clockwise and counter-clockwise helically oriented fibers formed of glass and having a helically extending fiber formed of carbon.

Additional dry fiber layers, beyond the initial composite layer 103 of FIG. 1, may enhance the capabilities of a composite tube. In particular, the interaction between the additional dry fiber layers may create a synergistic effect not found in a single composite layer.

Composite tube system 200 may have from about 1 to about 50 dry fiber layers, for example from about 2 to about 10 layers, or from about 3 to about 5 layers.

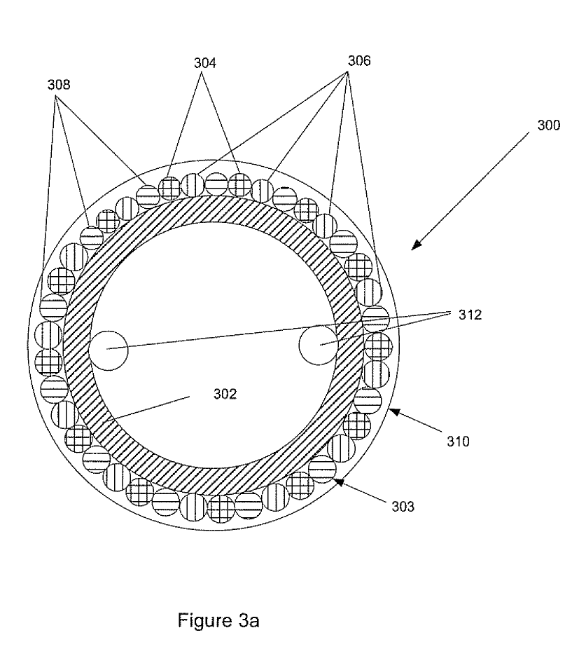

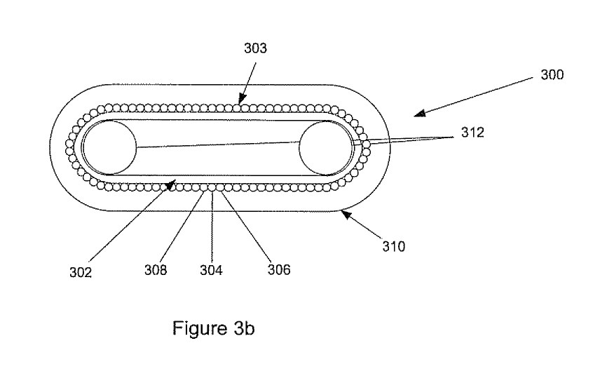

FIGS. 3a & 3b:

Referring now to FIG. 3a, composite tube system 300 is shown with inner liner 302, a dry fiber layer with fibers 304, 306, and 308, and an external protection layer 310, such as a sheath. The layer 310 may prevents gases or liquids (i.e. fluids) from penetrating into the composite tube. Composite tube system 300 also has radius controllers 312 which are used to protect the liner from severe localized bending when moving from an inflated configuration shown in FIG. 3a to a deflated configuration shown in FIG. 3b.

Layer 310 can be formed of a metal, thermoplastic, thermoset, or an elastomer such as a rubber sheet. All these various materials can function as a pressure barrier. Preferable properties of the pressure barrier layer may include low permeability to fluids (i.e., gases or liquids), high elongation, and/or long term durability in a service environment. Layer 310 can be formed of an impermeable material or polymers. For instance, polymeric layer could include a sheath formed of polyester, polyimide, polyamide, polyvinyl fluoride, polyvinylidene fluoride, polyethylene, and polypropylene, or other thermoplastics.

Layer 310 may also provide wear resistance, impact resistance, and an interface layer for the coupling for the composite tube. Layer 310 may be positioned on the exterior of tube 300. Layer 310 may provide abrasion resistance and wear resistance by forming an outer surface to the composite tube that has a low co-efficient of friction thereby causing objects to slip off the composite tube. Layer 310 can be formed of a filled or unfilled polymeric layer. Alternatively, layer 310 can be formed of a fiber, such as kevlar or glass, and a matrix.

Composite pipe system 300 in FIG. 3a is shown in an inflated configuration. System 300 may be inflated by pressurizing the inside of liner 302, and/or by depressurizing the outside of liner 302. The inflated configuration may be used when system 300 is deployed to transport fluids and/or gases through liner 302.

Composite pipe system 300 in FIG. 3b is shown in a deflated configuration. System 300 may be deflated by depressurizing the inside of liner 302, by pressurizing the outside of liner 302, and/or by other mechanical means. The deflated configuration may be used when system 300 is stored, for example on a ship, a platform, or on a reel or spool. Radius controllers 312 act to keep liner 302 from severe localized bending, and provide a smooth curved transition for liner 302.

Radius controllers 312 may have a diameter from about 2% to about 25% of the diameter of liner 302, for example from about 3% to about 15%, or from about 5% to about 10%.

### ILLUSTRATIVE EMBODIMENTS

In one embodiment, there is disclosed a system comprising a liner at an interior of the pipe; at least one dry fiber tri-axial braid layer exterior to the liner, the tri-axial braid layer comprising a plurality of axial fibers, a plurality of clockwise fibers, and a plurality of counterclockwise fibers. In some embodiments, the system also includes a plurality of dry fiber tri-axial braid layers exterior to the liner. In some embodiments, the system also includes a sheath exterior to the at least one dry fiber tri-axial braid layers. In some embodiments, the system also includes one or more radius controllers interior to the liner. In some embodiments, the pipe system can alternate between an inflated and a deflated configuration. In some embodiments, the deflated configuration comprises a height from about 10% to about 50% of a height of the inflated configuration, for example from about 20% to about 40%.

In one embodiment, there is disclosed a method of manufacturing a pipe, comprising providing a liner; and triaxially braiding a plurality of fibers about the liner to form at least one dry fiber layer. In some embodiments, the method also includes installing a sheath about the at least one dry fiber layer. In some embodiments, the method also includes positioning one or more radius controllers within the liner. In some embodiments, the method also includes triaxially braiding a plurality of dry fiber layers exterior to the liner.

In some embodiments, composite pipes of the invention may be used with most any type of offshore structure, for example, bottom supported and vertically moored structures, for example, fixed platforms, compliant towers, tension leg platforms, and mini-tension leg platforms, and also include floating production and subsea systems, for example, spar platforms, floating production systems, floating production storage and offloading, and subsea systems.

While the illustrative embodiments of the invention have been described with particularity, it will be understood that various other modifications will be apparent to and can be readily made by those skilled in the art without departing from the spirit and scope of the invention. Accordingly, it is not intended that the scope of the claims appended hereto be limited to the examples and descriptions set forth herein but rather that the claims be construed as encompassing all the features of patentable novelty which reside in the invention, including all features which would be treated as equivalents thereof by those skilled in the art to which this invention pertains.

1. A pipe system comprising:
a liner at an interior of the pipe;
at least one dry fiber tri-axial braid layer exterior to the liner, the tri-axial braid layer comprising a plurality of axial fibers, a plurality of clockwise fibers, and a plurality of counterclockwise fibers.

2. The system of claim 1, further comprising a plurality of dry fiber tri-axial braid layers exterior to the liner.

3. The system of claim 1, further comprising a sheath exterior to the at least one dry fiber tri-axial braid layers.

4. The system of claim 1, further comprising one or more radius controllers interior to the liner.

5. The system of claim 1, wherein the pipe system can alternate between an inflated and a deflated configuration.

6. The system of claim 5, wherein the deflated configuration comprises a height from about 10% to about 50% of a height of the inflated configuration, for example from about 20% to about 40%.

7. A method of manufacturing a pipe, comprising:
providing a liner; and
triaxially braiding a plurality of fibers about the liner to form at least one dry fiber layer.

8. The method of claim 7, further comprising installing a sheath about the at least one dry fiber layer.

9. The method of one or more of claims 7-8, further comprising:
positioning one or more radius controllers within the liner.

10. The method of claim 7, further comprising triaxially braiding a plurality of dry fiber layers exterior to the liner.
